(19) United States
(12) Patent Application Publication
(10) Pub. No.: US 2004/0167230 A1
(43) Pub. Date: Aug. 26, 2004

(54) Method for preparing ultra-fine dispersion solutions

(75) Inventors: Wei-Yi Chien, Keelung City (TW); Ching-Tien Hsu, Tucheng City (TW); Shu-Ya Tsai, Hsinchu City (TW); Shu-Chen Tsou, Hsinchu City (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/747,126

(22) Filed: Dec. 30, 2003

(30) Foreign Application Priority Data
Dec. 30, 2002 (TW) 091137896

(51) Int. Cl. B01F 3/00

(52) U.S. Cl. 516/9

(57) ABSTRACT

A method for preparing ultra-fine dispersion solutions is disclosed. First, at least one dispersant is dissolved in a liquid carrier, to which a matrix is added to form a mixture, wherein the difference between the mean HLB value of the dispersant and the HLB value of the matrix is less than or equal to 3, the weight percentage of the matrix ranges from 0.1 wt % to 70 wt % of the mixture, and the weight percentage of the dispersant ranges from 0.1 wt % to 30 wt % of the mixture. Next, the mixture is comminuted with a milling media in milling equipment to form a dispersion solution, in which the particle size of the matrix becomes 10 μm to 100 μm, wherein the particle size of the milling media ranges from 100 μm to 400 μm. Finally, the milling media are separated from the dispersion solution.

### BACKGROUND OF THE INVENTION

1. Field of the Invention

The present invention relates to a method for preparing ultra-fine dispersion solutions and, more particularly, to comminuting of pigments, organic compounds, metals, metallic oxides, and medicine compounds using wet milling and dispersion techniques.

2. Description of Related Art

Currently, a comminuting technique is the critical manufacturing technique in many industries, wherein wet milling is a relatively economic process and applicable to various materials. Resulting products are accordingly found throughout the appropriate downstream industries, for example, the dispersion solutions. The dispersion solutions of pigments are widely used in fields of painting, ink, pigment, and industrial dying. Through the exploiting of comminuting techniques, such as better design of milling equipment, or use of various dispersants and application of different kinds or sizes of milling media, the nano-scale particle dispersions may be obtained by wet milling.

Take the milling media for example, it is well known that particularly fine milling media are required to obtain the smaller particle size of pigments. However, the source of suitable fine milling media is limited, unlike the widely-available and inexpensive milling media with large size. In addition to those disadvantages of the fine milling media, a further problem exists in that such media with a particle size smaller than 0.1 mm will block the sieve during separation and thus cannot be used in either horizontal or vertical circulation types of dispersing systems. Therefore, it is desirable to provide a method for preparing ultra-fine dispersion solutions to mitigate and/or obviate the aforementioned problems.

### SUMMARY OF THE INVENTION

The object of the present invention is to provide a method for preparing ultra-fine dispersion solutions so that the particle size of pigments can be comminuted to nano-size, which results in the improvements of saturation extent and transparency of color.

Another object of the present invention is to provide a method for preparing ultra-fine dispersion solutions so that the nano-scale of pigments can be obtained through a simplified comminution process, relatively large milling media, and a lower cost.

To achieve the object, the method for preparing ultra-fine dispersion solutions of the present invention includes the following steps. First, at least one dispersant is dissolved in a liquid carrier, to which a matrix is added to form a mixture, wherein the difference between the mean HLB value of said dispersant and the HLB value of said matrix is less than or equal to 3, the weight percentage of said matrix ranges from 0.1 wt % to 70 wt % of said mixture, and the weight percentage of said dispersant ranges from 0.1 wt % to 30 wt % of said mixture. Afterwards, said mixture is comminuted with a milling medium in milling equipment to form a dispersion solution, in which the particle size of said matrix becomes 10 μm to 100 μm, wherein the particle size of said milling medium ranges from 100 μm to 400 μm. Finally, said milling medium is separated from said dispersion solution.

Other objects, advantages, and novel features of the invention will become more apparent from the following detailed description.

### DETAILED DESCRIPTION OF THE PREFERRED EMBODIMENT

The matrix (the material to be comminuted) used in the method of preparing ultra-fine dispersion solutions of the present invention is not restricted, and could be an organic compound, a metal, a metallic oxide, an organic pigment, an inorganic pigment, a dyestuff, or a medicine compound. Preferably, the weight percentage of the matrix ranges from 0.1 wt % to 70 wt % of the mixture. More preferably, the weight percentage of the matrix ranges from 0.1 wt % to 40 wt % of the mixture. The weight percentage of the dispersant is preferably ranging from 0.1 wt % to 30 wt % of the mixture, and is more preferably ranging from 0.1 wt % to 20 wt % of the mixture. The liquid carrier used in the present invention may be water or a solution that contains at least an water-miscible solvent, and water is preferred. The water-miscible solvent is not restricted and could be alcohol, ether, ketone, or ester. The material used to make the milling media is not restricted. The milling media can be made of polymer resins, ceramics, glasses, metals, or stainless steels. Preferably, the milling media are made of ceramics or polymer resins. More preferably, the ceramics are yittrium oxides or zirconium oxides. It is optional to add a step (C′) diluting the dispersion solution to a desired concentration or a step (C″) adding an additive or an assistant agent to make the dispersion solution meet the required physical and chemical properties before or after separating said milling media from said dispersion solution in step (C). The milling equipment used in the method for preparing dispersion solution of the present invention is not restricted, and can be vertical or horizontal milling equipment, such as an airjet mill, a roller miller, an attritor mill, a vibratory mill, a planetary mill, a sand mill, a bead mill, a pebble mill, a fine media mill, or a shot mill. The dispersant of the present invention can be any conventional surfactant. For example, the surfactant such as anionic, cationic, non-ionic, polymeric surfactants, and their mixtures mentioned in literature widely available to those skilled in the art are suitable. Preferably, the dispersant is a polyacrylate, formaldehyde condensates of sulfonated aromatic compounds, conventional alkyl or aryl polyethoxylates, polyurethane type, core-shell polymer, polyester, polyamino acid dispersant, block copolymer, photo-crosslinkable polymeric dispersant, star polymer, polymeric dispersant, oligomeric dispersant, polyamine/fatty acid condensation polymeric dispersant, or modified acrylamide oligomer dispersant. More preferably, the dispersant is polyoxyethylene sorbitan fatty acid ester, octyl phenol polyethylene glycol ether, fatty alcohol polyethylene glycol ether, polyoxypropylene polyoxyethylene ether, fatty acid polyethylene glycol ether, castol oil polyethylene glycol ether, sulfosuccinate monoester, di-octyl sulfouccinate, dodecyl benzene sulfonate, naphthalene formaldehyde condensate, miscellaneous dialkyl ammonium methosulfate, polyoxethylene alkyl ether, polythylene glycol fatty acid, amine ethoxylate, polyoxylethylene di-styrenated phenol, nonyl phenyl ether phosphate, polyoxyethylene di-styrenated cresol, condensated arylsulfonic acid, aromatic polyether based dispersant, alkylphenol ehtoxylates, butyl glycol, or N-methyl-N-oleoyl taurate.

### COMPARATIVE EXAMPLE 1

### The Preparation of Cyan Pigment Dispersion

TABLE 1

| Component | Amount(g) |
|---|---|
| Ciba Irgalite Blue GLO ™ | 27 |
| Pannox 150A ™ | 14.85 |
| Water | 131.8 |
| Total | 180 |
| Milling media: 150˜360 μm crosslinked | 260.3 |
| Polystyrene beads | |

The ingredients listed in Table 1 were well mixed and comminuted in a one-liter stainless steel container having a cooling sheath, which was equipped with an IKA ULTRA-TURRAX T50™ motor, and a cowls milling blade that was 5 cm in length. The comminution was carried out with a tip speed of 7.85 m/s for 8 hrs and a cooling water maintained at 15° C. After that, 50 g of water was added to dilute the dispersion solution. Then, the milling media were separated from the dispersion solution. The particle size of the dispersion solution was measured using a Dynamic Light Scattering of Marlvern 4700™ type, which resulted in a mean particle size of 129.5 nm. The difference between the HLB value of the pigment and that of Pannox 150A™ was 5.1.

### COMPARATIVE EXAMPLE 2

### The Preparation of Magenta Pigment Dispersion

TABLE 2

| Component | Amount(g) |
|---|---|
| Sunfast PR122 ™ | 27 |
| Sinpol 960 ™ | 10.8 |
| Water | 142.2 |
| Total | 180 |
| Milling media: 150˜360 μm crosslinked | 200 |
| Polystyrene beads | |

The preparation procedure is the same as comparative Example 1 except that the tip speed is 7.6 m/s and the time of comminution is 6 hrs. The mean particle size is larger than 2 μm, wherein the difference between the HLB value of the pigment and that of Sinpol 960™ was 3.6.

### EXAMPLE 1

### The Preparation of Cyan Pigment Dispersion

TABLE 3

| Component | Amount(g) |
|---|---|
| Ciba Irgalite Blue GLO ™ | 27 |
| Milliken 8334 ™ | 14.3 |
| Water | 138.7 |
| Total | 180 |
| Milling media: 150˜250 μm crosslinked | 289.5 |
| Polystyrene beads | |

The ingredients listed in Table 3 were well mixed and comminuted in a one-liter stainless steel container having a cooling sheath, which was equipped with an IKA ULTRA-TURRAX T50™ motor, and a cowls milling blade that was 5 cm in length. The comminution was carried out with a tip speed of 7.85 m/s for 7.5 hrs and a cooling water maintained at 15° C. After that, 50 g of water was added to dilute the dispersion solution (wherein the concentration of pigment is 11.75%) and stirred for 30 mins. Then, the milling media were separated from the dispersion solution. The particle size of the dispersion solution was measured using a Dynamic Light Scattering of Marlvern 4700™ type, which resulted in a mean particle size of 21.8 nm. The difference between the HLB value of the pigment and that of Milliken 8334™ was 1.0.

### EXAMPLE 2

### The Preparation of Blue Pigment Dispersion

TABLE 4

| Component | Amount(g) |
|---|---|
| Ciba Irgalite atlantic 870-CF ™ | 27 |
| Sinpol 610 ™ | 13.5 |
| Water | 139.5 |
| Total | 180 |
| Milling media: 150˜360 μm crosslinked | 259.4 |
| Polystyrene beads | |

The preparation procedure is the same as Example 1 except that the tip speed is 4.32 m/s and the time of comminution is 6 hrs. The mean particle size is 25.7 nm, wherein the difference between the HLB value of the pigment and that of Sinpol 610™ was 2.4.

### EXAMPLE 3

### The Preparation of Magenta Pigment Dispersion

TABLE 5

| Component | Amount(g) |
|---|---|
| Sunfast PR122 ™ | 36 |
| Milloken 8216 ™ | 18 |
| Water | 126 |
| Total | 180 |
| Milling media: 150˜250 μm crosslinked | 238.6 |
| Polystyrene beads | |

The preparation procedure is the same as Example 1 except that the tip speed is 6.2 m/s and the time of comminution is 17 hrs. The water added for dilution was 70 g and a mean particle size of 42.4 nm was achieved, wherein the difference between the HLB value of the pigment and that of Milliken 8216™ was 1.5.

### EXAMPLE 4

### The Preparation of Magenta Pigment Dispersion

TABLE 6

| Component | Amount(g) |
|---|---|
| Sunfast PR122 ™ | 31.5 |
| Sinpol 609 ™ | 9.45 |
| Water | 169.05 |
| Total | 210 |
| Milling media: 150˜250 μm crosslinked | 245.1 |
| Polystyrene beads | |

The preparation procedure is the same as Example 1 except that the tip speed is 8.33 m/s and the time of comminution is 7 hrs. The water added for dilution was 120 g and a mean particle size of 76.7 nm was achieved, wherein the difference between the HLB value of the pigment and that of Sinpol 609™ was 1.4.

### EXAMPLE 5

### The Preparation of Yellow Pigment Dispersion

TABLE 7

| Component | Amount(g) |
|---|---|
| Ciba Irgalite Yellow GS ™ | 36 |
| Milliken 334/8216 ™ | 3.6/14.4 |
| Water | 126 |
| Total | 180 |
| Milling media: 150˜350 μm crosslinked | 265 |
| Polystyrene beads | |

The preparation procedure is the same as Example 1 except that the tip speed is 6.7 m/s and the time of comminution is 10 hrs. The mean particle size was 51.8 nm, wherein the difference between the HLB value of the pigment and the average HLB value of dispersants was 0.2.

The difference between the median of the HLB value of the pigment and the average HLB value of dispersants, i.e. ΔHLB and the mean particle size of the prepared dispersion solution in each of the aforementioned comparative examples and examples are summarized in the following Table 8:

TABLE 8

| | ΔHLB | Mean particle size |
|---|---|---|
| Comparative Example 1 | 5.1 | 129.5 nm |
| Comparative Example 2 | 3.6 | >2 μm |
| Example 1 | 1.0 | 21.8 nm |
| Example 2 | 2.4 | 25.7 nm |
| Example 3 | 1.5 | 42.4 nm |

From Table 8, it is obvious that the method of the present invention does comminute the dispersion solution to a particle size of less than 30 nm using milling media ranging from 100 to 400 μm. The critical point is that the difference between the dispersants and the matrices is not larger than 3, which makes the matrices become moistened adequately by the dispersants due to their similar polarities. Therefore, the matrices are well comminuted and stabilized. The method of the present invention for preparing ultra-fine dispersion solutions successfully comminutes the matrices to particles of a nano-scale size by using the generally used and cheap milling media, and thus provides a simplified comminuting process with low cost.

Although the present invention has been explained in relation to its preferred embodiment, it is to be understood that many other possible modifications and variations can be made without departing from the scope of the invention as hereinafter claimed.

What is claimed is:

1. A method for preparing ultra-fine dispersion solutions comprising the following steps:
(A) dissolving at least a dispersant in a liquid carrier, to which a matrix is added to form a mixture, wherein the difference between the mean HLB value of said dispersant and the HLB value of said matrix is less than or equal to 3, the weight percentage of said matrix ranges from 0.1 wt % to 70 wt % of said mixture, and the weight percentage of said dispersant ranges from 0.1 wt % to 30 wt % of said mixture;
(B) comminuting said mixture with a milling media in milling equipment to form a dispersion solution, in which the particle size of said matrix becomes 10 μm to 100 ∞m, wherein the particle size of said milling media ranges from 100 μm to 400 μm; and
(C) separating said milling media from said dispersion solution.

2. The method as claimed in claim 1, wherein said matrix is selected from the group consisting of organic compounds, metals, metallic oxides, organic pigments, inorganic pigments, dyestuffs, medicine compounds, and combinations thereof.

3. The method as claimed in claim 1, wherein the weight percentage of said matrix ranges from 1 wt % to 40 wt % of said mixture.

4. The method as claimed in claim 1, wherein the weight percentage of said dispersant ranges from 1 wt % to 20 wt % of said mixture.

5. The method as claimed in claim 1, wherein said liquid carrier is water or a solution that contain a water-miscible solvent.

6. The method as claimed in claim 5, wherein said water-miscible solvent is selected from the group consisting of alcohol, ether, ketone, and ester.

7. The method as claimed in claim 1, wherein said milling media are made of the materials selected from the group consisting of polymer resin, ceramics, glass, metal, stainless steel, and a combination thereof.

8. The method as claimed in claim 7, wherein said ceramics is yittrium oxide or zirconium oxide.

9. The method as claimed in claim 1 further comprising a step (C′) diluting said dispersion solution to a desired concentration before or after said step (C).

10. The method as claimed in claim 1, wherein said milling equipment is vertical or horizontal.

11. The method as claimed in claim 1, wherein said milling equipment is selected from the group consisting of an airjet mill, a roller miller, an attritor mill, a vibratory mill, a planetary mill, a sand mill, a bead mill, a pebble mill, a fine media mill and a shot mill.
